(19) United States
(12) Patent Application Publication
(10) Pub. No.: US 2024/0108446 A1
(43) Pub. Date: Apr. 4, 2024

(54) RECHARGEABLE ELECTRIC TOOTHBRUSH

(71) Applicant: QUIP NYC INC, Brooklyn, NY (US)

(72) Inventors: Michael J. LAWLOR, New York, NY (US); Jonathan Henry FRATTI, Brooklyn, NY (US); Eric Glenn HARSH, Brooklyn, NY (US); Simon J. M. ENEVER, Brooklyn, NY (US); William MAY, Purcellville, VA (US); Sean James WILSON, Hoboken, NJ (US); Jonathan Pradeep AUSTIN, Johns Creek, GA (US); James C. KRAUSE, Long Island City, NY (US); Paul B. KOH, New York, NY (US)

(21) Appl. No.: 18/479,732

(22) Filed: Oct. 2, 2023

Related U.S. Application Data
(60) Provisional application No. 63/412,172, filed on Sep. 30, 2022.

(51) Int. Cl. A61C 17/22

(52) U.S. Cl. CPC A61C 17/225; A61C 17/221; A61C 17/224

(57) ABSTRACT

According to one aspect, an electric toothbrush may include a handle, a brush head, a rechargeable battery, an electric motor, and a pair of electrical contacts. The handle may have a first end region and a second end region defining a longitudinal axis therebetween, the handle defining a volume from the first end region to the second end region. The brush head may include bristles, the brush head releasably securable to the first end region of the handle. The rechargeable battery may be in the volume. The electric motor may be at least partially disposed in the volume, the electric motor in electrical communication with the rechargeable battery, the electric motor in mechanical communication with the brush head. The pair of electrical contacts may be in electrical communication with the rechargeable battery, and the pair of electrical contacts axially and radially spaced from one another, relative to the longitudinal axis.

### CROSS-REFERENCE TO RELATED APPLICATIONS

This application claims the benefit of priority to U.S. Provisional Patent Application No. 63/412,172, filed on Sep. 30, 2022, the entire contents of which are hereby incorporated herein by reference.

### BACKGROUND

Toothbrushing is important for maintaining good oral health. A toothbrush typically includes a brush head and a handle coupled to one another. The brush head includes a plurality of bristles. With toothpaste applied to the plurality of bristles of the brush head, a user may grasp the handle to move the plurality of bristles in the user's mouth to clean the user's teeth, gum, and tongue. Although manual toothbrushes can be used to clean teeth, electric toothbrushes facilitate achieving superior and more consistent cleaning, potentially reducing incidences of dental diseases.

Electric toothbrushes are typically reliant on batteries that allow the user to move freely but deplete over time. Rechargeable batteries can provide users with a convenient way to ensure that an electric toothbrush has sufficient power before each use. However, the electronics required for integrating a rechargeable battery in an electric toothbrush can result in a bulky form factor that may be uncomfortable—or even unwieldy—for users and may limit the ability to use the electronic toothbrush while traveling or otherwise away from home.

### SUMMARY

Devices, systems, and methods of the present disclosure are generally directed to various, different aspects of integrating electronics of rechargeable electric toothbrushes into a convenient form factor that may be reliably and cost-effectively produced at scale.

According to one aspect, an electric toothbrush may include a handle having a first end region and a second end region defining a longitudinal axis therebetween, the handle defining a volume from the first end region to the second end region, a brush head including bristles, the brush head releasably securable to the first end region of the handle, a rechargeable battery disposed in the volume, an electric motor at least partially disposed in the volume, the electric motor in electrical communication with the rechargeable battery, the electric motor in mechanical communication with the brush head, and a pair of electrical contacts in electrical communication with the rechargeable battery, and the pair of electrical contacts axially and radially spaced from one another, relative to the longitudinal axis.

In certain implementations, each one of the pair of electrical contacts may be radially centered about the longitudinal axis of the handle.

In some implementations, each one of the pair of electrical contacts may be symmetric about any plane containing the longitudinal axis.

In certain implementations, the pair of electrical contacts may be partially disposed in the volume of the handle, and each one of the pair of electrical contacts extends, from the volume, and through the second end region of the handle. In some instances, the electric toothbrush may further include a chassis cap supported on the second end region of the handle, wherein the second end region of the handle, the chassis cap, and the pair of electrical contacts collectively form continuous surface of the electric toothbrush with at least a portion of the chassis cap disposed between the pair of electrical contacts along the continuous surface. As an example, one or more of the pair of electrical contacts may be secured to the chassis cap via a pressure sensitive adhesive. Additionally, or alternatively, one or more of the pair of electrical contacts may be insert molded in the chassis cap. Additionally, or alternatively, the electric toothbrush may further include a printed circuit board disposed in the volume of the handle and in electrical communication with the rechargeable battery, wherein at least one of the pair of electrical contacts includes a tab that restricts longitudinal movement the printed circuit board relative to the chassis cap within the volume of the handle. The printed circuit board may include, for example, circuitry for selectively interrupting electrical communication between the rechargeable battery and the electric motor.

In some implementations, the electric toothbrush may further include a first chassis section and a second chassis section, wherein the electric motor is releasably securable to the first chassis section and removable from the volume of the handle via the first end region of the handle with the brush head disconnected from the first end region of the handle, and the rechargeable battery is disposed longitudinally between the second chassis section and the chassis cap. The first chassis section, the second chassis section, and the chassis cap may each be discrete from one another and independently positionable within the volume, a longitudinal position of the first chassis section is keyed to a first datum face of the first end region of the handle, and a longitudinal position of the chassis cap is keyed to a second datum face of the second end region of the handle. In some instances, the first chassis section may define a plurality of grooves, and the first chassis section is coupled to the handle via adhesive in the grooves between the first chassis section and the handle. In certain implementations, the first chassis section and the second chassis section may be longitudinally spaced from one another in the volume of the handle. Further, or instead, the second chassis section and the chassis cap may be engageable with one another through snap-fit engagement. Additionally, or alternatively, the second chassis section may be disposed between the rechargeable battery and the electric motor along the longitudinal axis, and the rechargeable battery is disposed between the second chassis section and the chassis cap in the volume of the handle. In some instances, one of the pair of electrical contacts may define an orifice along the continuous surface, and the orifice is in fluid communication with the rechargeable battery. In certain instances, the electric toothbrush may further include a first membrane disposed, in the volume, longitudinally between the rechargeable battery and the orifice, wherein the first membrane is gas permeable and water impermeable. In some instances, the electric toothbrush may further include a second membrane disposed, in the volume, longitudinally between the rechargeable battery and the electric motor, wherein the second membrane is gas permeable and water impermeable. In certain instances, the electric toothbrush may include a flexible contact supported on the second chassis section, wherein a positive contact of the electric motor, a positive terminal of the rechargeable battery, and the printed circuit board are in electrical communication with one another via the flexible contact. As an example, the flexible contact may include a spring contact in contact with the positive contact of the electric motor and biased in a longitudinal direction from the second end region toward the first end region. The spring contact may be heat staked to the second chassis section. Further, or instead, the flexible contact may include a strip contact insert molded into the chassis cap. Additionally, or alternatively, the flexible contact may include one or more wires soldered on the printed circuit board. In some instances, the electric toothbrush may include a spring finger contact supported on the printed circuit board and in contact with a negative terminal of the rechargeable battery. In certain instances, a portion of the first chassis section and a portion of the electric motor may each extend from the volume of the handle, through the first end region of the handle, into the brush head.

In certain implementations, the pair of electrical contacts may include a ring contact and a center contact, and the ring contact circumscribes the center contact.

In some implementations, at least one of the pair of electrical contacts may be ferromagnetic and electrically conductive. For example, the at least one of the pair of electrical contacts may be at least partially formed of ferritic stainless-steel type 430.

In certain implementations, the electric toothbrush may include a permanent magnet encapsulated within the volume of the handle along the second end region of the handle. As an example, the permanent magnet may be radially between the pair of electrical contacts.

In some implementations, the electric toothbrush may include a gasket disposed in the volume of the handle, wherein the gasket circumscribes the pair of electrical contacts along the second end region of the handle.

According to another aspect, a dental care system may include an electric toothbrush including a handle, a brush head, and a pair of electrical contacts, the brush head supported on the handle, and the pair of electrical contacts supported on the handle away from the brush head, and a case defining a first opening and a second opening, the case defining a cavity from the first opening to the second opening, the case positionable about at least a portion of the handle with at least a portion of the electric toothbrush extending through the first opening and the pair of electrical contacts accessible in the cavity through the second opening from an environment outside of the case.

In some implementations, the dental care system may include a charger including a connector releasably positionable in the second opening of the case and, with the connector in the second opening, the connector in electrical communication with the pair of electrical contacts. For example, with the connector in the second opening, the electric toothbrush may be stably supportable in a vertical orientation on a flat surface, and the brush head is away from the flat surface with the electric toothbrush in the vertical orientation. In some instances, the handle of the electric toothbrush may include a first magnet adjacent to the pair of electrical contacts, the connector of the charger includes a second magnet, and forces of the first magnet and the second magnet on one another align the pair of electrical contacts of the electric toothbrush with the connector in a predetermined orientation.

In certain implementations, the case may include an adhesive on an outer surface of the case, the case mountable to a mirror via the adhesive.

According to another aspect, a method of controlling over-discharging of a rechargeable oral care device may include determining a cumulative activity time for an electric motor selectively actuatable to direct mechanical energy to a dental implement, disabling the electric motor when the cumulative activity time reaches a predetermined threshold time, monitoring a duration of an electrical charging session of a battery in electrical communication with the electric motor, comparing the duration of the electrical charging session to a predetermined trigger value, and resetting the cumulative activity time for the electric motor when the duration of the electrical charging session reaches the predetermined trigger value.

In some implementations, determining the cumulative activity time for the electric motor may include detecting cumulative duration of an on state of the electric motor cycling between the on state and an off state. As an example, disabling the electric motor may include maintaining the electric motor in the off state.

In some implementations, disabling the electric motor may include providing a warning signal to a user. In some instances, the warning signal may include actuating the electric motor to generate a predetermined vibration pattern.

In certain implementations, disabling the electric motor may include receiving the predetermined threshold time via wireless communication, wired communication, or a combination thereof.

In some implementations, monitoring the duration of the electrical charging session may include detecting electrical energy directed to the battery.

In certain implementations, resetting the cumulative activity time for the electric motor may include enabling the electric motor following disablement of the electric motor.

In some implementations, resetting the cumulative activity time for the electric motor may include power cycling of the electric motor, and the power cycling interrupts electrical communication between the battery and the electric motor for a predetermined interruption period. In some instances, resetting the cumulative activity time for the electric motor may include reestablishing electrical communication between the battery and the electric motor following interruption of the electrical communication. In certain instances, resetting the cumulative activity time for the electric motor may include decrementing the cumulative activity time for the electric motor to zero. The predetermined interruption period may be greater than 5 seconds and less than 60 seconds (e.g., 15 seconds). Further, or instead, resetting the cumulative activity time for the electric motor may include receiving the predetermined interruption period via wireless communication, wired communication, or a combination thereof.

In certain implementations, the predetermined threshold time for disabling the electric motor is greater than 6 hours and less than 10 hours. As an example, the predetermined threshold time for disabling the electric motor may be 8 hours.

In some implementations, the predetermined trigger value for resetting the cumulative activity time for the electric motor may be greater than 10 minutes and less than 60 minutes. The predetermined trigger value for resetting the cumulative activity time may be 30 minutes.

In certain implementations, resetting the cumulative activity time for the electric motor may include maintaining the battery and the electric motor fluidically sealed from the dental implement in mechanical communication with the electric motor.

In some implementations, comparing the duration of the electrical charging session to the predetermined trigger value may include receiving the predetermined trigger value via wireless communication, wired communication, or a combination thereof.

According to yet another aspect, a controller for charging an electric toothbrush may include one or more processors, and a memory including at least one non-transitory, computer-readable storage medium communicatively coupled to the one or more processors, the at least one non-transitory, computer readable storage medium having stored thereon instructions for causing the one or more processors to carry out any one of the foregoing methods.

### BRIEF DESCRIPTION OF THE DRAWINGS

FIG. 1A is a top-left-front perspective view of a dental care system including an electric toothbrush, a case, and a charger.

FIG. 1B is a side, cross-sectional view of the dental care system of FIG. 1A, with the cross-section taken along 1B-1B in FIG. 1A.

FIG. 2A is a bottom-left-front perspective view of the electric toothbrush and the case of the dental care system of FIG. 1A, shown with the electric toothbrush disposed in the case.

FIG. 2B is a rear perspective view of the electric toothbrush and the case of the dental care system of FIG. 1A, shown with the electric toothbrush disposed in the case.

FIG. 2C is a top-left-front perspective view of the electric toothbrush and the case of the dental care system of FIG. 1A, shown with the electric toothbrush removed from the case.

FIG. 2D is a is a front-left-bottom perspective view of the electric toothbrush and the case of the dental care system of FIG. 1A, shown with the electric toothbrush removed from the case.

FIG. 2E is a rear perspective view of the electric toothbrush and the case of the dental care system of FIG. 1A, shown with the electric toothbrush removed from the case.

FIG. 3A is a top-left-front perspective view of a portion of the electric toothbrush of the dental care system of FIG. 1A, shown with a brush head of the electric toothbrush removed.

FIG. 3B is a side, cross-sectional view of the portion of the electric toothbrush shown in FIG. 3A, with the cross-section taken along 3B-3B in FIG. 3A.

FIG. 3C is an enlarged view of the portion of the electric toothbrush shown in FIG. 3A, along the area of detail 3C in FIG. 3A.

FIG. 3D is an enlarged view of the portion of the electric toothbrush shown in FIG. 3A, along the area of detail 3D in FIG. 3A.

FIG. 3E is an enlarged view of the portion of the electric toothbrush shown in FIG. 3A, along the area of detail 3E in FIG. 3A.

FIG. 4 is a flow chart of an exemplary method of controlling over-discharging of a rechargeable oral care device.

Like reference symbols in the various drawings indicate like elements.

### DETAILED DESCRIPTION

Embodiments will now be described more fully hereinafter with reference to the accompanying figures, in which exemplary embodiments are shown. The foregoing may, however, be embodied in many different forms and should not be construed as limited to the exemplary embodiments set forth herein. All fluid flows may flow through conduits (e.g., pipes and/or manifolds) unless specified otherwise.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

In the description that follows, devices, systems, and methods are generally described in the context of electric toothbrushes for the sake of clear and efficient description of various features. Unless otherwise specified or made clear from the context, it should be more generally understood that devices, systems, and methods described herein may be used in the context of other types of dental care devices. Thus, for example, unless a contrary intent is explicitly set forth, the devices, systems, and methods described herein may be used in the context of oral irrigators.

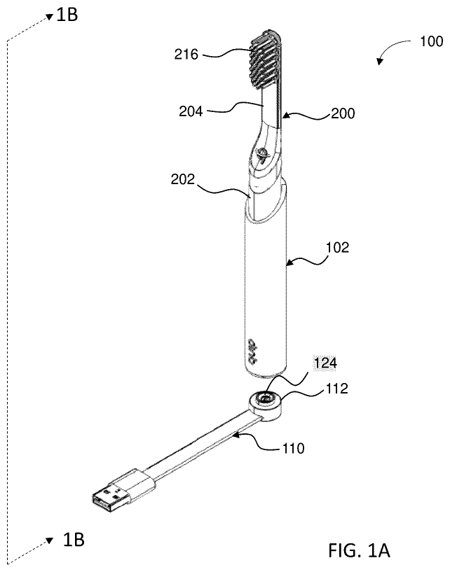

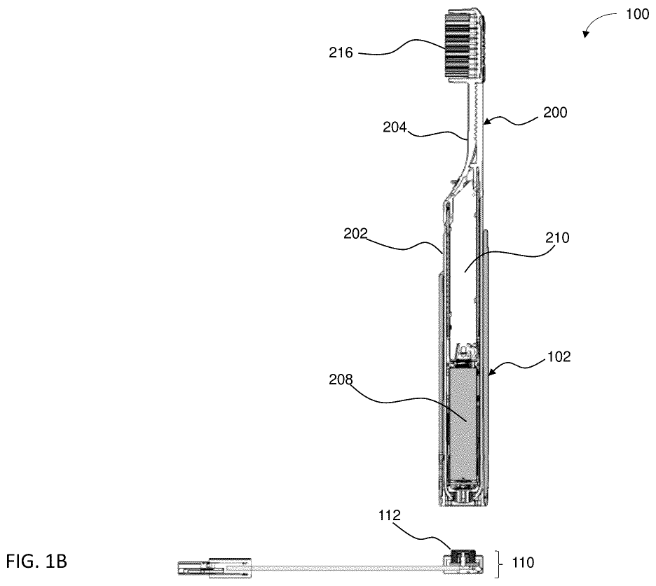

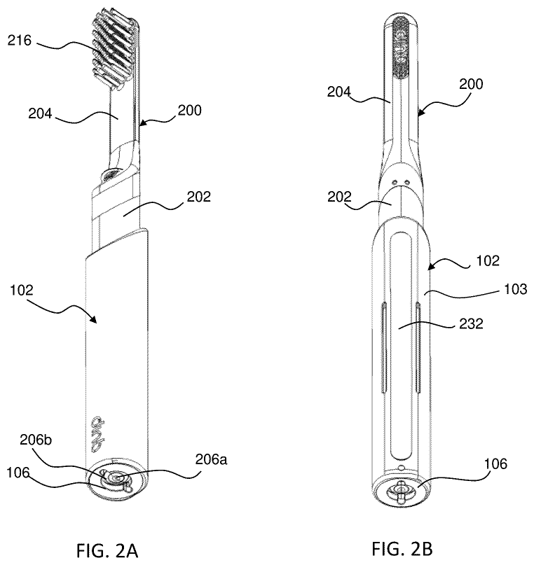

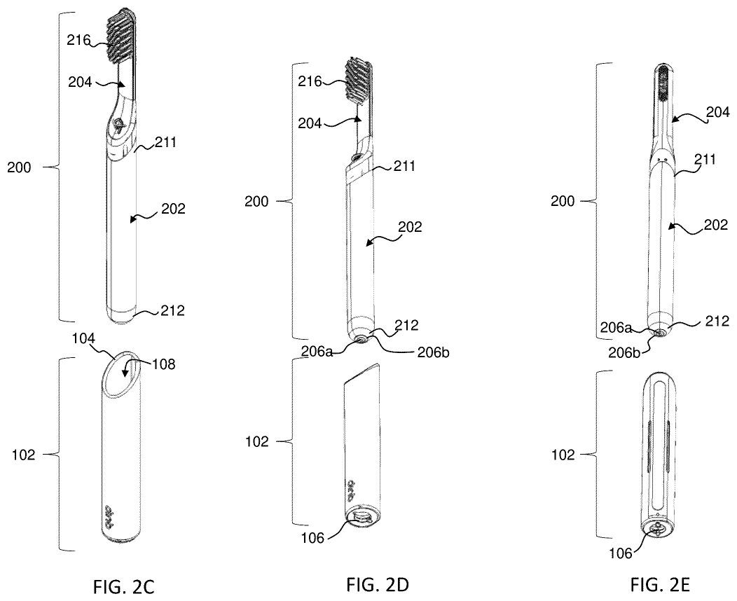

Referring now to FIGS. 1A and 1B, FIGS. 2A-2E, and FIGS. 3A-3E, a dental care system 100 may include a case 102 and an electric toothbrush 200. As described in greater detail below, the electric toothbrush 200 may include a handle 202, a brush head 204, and a pair of electrical contacts 206a,206b. As also described in greater detail below, the brush head 204 may be supported on the handle 202, and the pair of electrical contacts 206a,206b may be supported on the handle 202 away from the brush head 204.

The case 102 may define a first opening 104 and a second opening 106, with the case 102 defining a cavity 108 from the first opening 104 to the second opening 106. The case 102 may be positionable about at least a portion of the of the handle 202 with at least a portion of the electric toothbrush 200 extending through the first opening 104 and the pair of electrical contacts 206a,206b accessible in the cavity 108 through the second opening 106 from an environment outside of the case 102. The case 102 of the dental care system 100 may further, or instead, include an adhesive 232 on an outer surface 103 of the case 102, the case mountable to a mirror via the adhesive 232.

The dental care system 100 may additionally or alternatively include a charger 110 including a connector 112 releasably positionable in the second opening 106 of the case 102. With the connector 112 in the second opening 106, the connector 112 may be in electrical communication with the pair of electrical contacts 206a,206b such that the electric toothbrush 200 may be recharged from an external power source, via the charger 110 (e.g., according to any one or more of the various different techniques described herein). In some instances, the connector 112 may support the case 102 and electric toothbrush 200 in a vertical position for charging. That is, with the connector 112 in the second opening 106, the electric toothbrush 200 may be stably supportable in a vertical orientation on a flat surface, with the brush head 204 away from the flat surface as is generally useful for maintaining a hygienic condition of the brush head 204. The handle 202 of the electric toothbrush 200 may include a first magnet 224 adjacent to the pair of electrical contacts 206a,206b, and the connector 112 of the charger 110 may include a second magnet 124. The forces of the first magnet 224 and the second magnet 124 on one another may then align the pair of electrical contacts 206a,206b of the electric toothbrush with the connector 112 in a predetermined orientation upon insertion of the connector 112 into the second opening 106. Additional, or alternative, aspects of the charger 110 are described in U.S. patent application Ser. No. 18/449,637, filed Aug. 14, 2023, entitled “ORAL IRRIGATION,” the entire contents of which are hereby incorporated herein by reference.

In general, the electric toothbrush 200 may include the handle 202, the brush head 204, and the pair of electrical contacts 206a,206b. The handle 202 may have a first end region 211 and a second end region 212 defining a longitudinal axis L therebetween, with the handle 202 defining a volume 214 from the first end region 211 to the second end region 212. The brush head 204 may include bristles 216 and, in some instances, the brush head 204 may be releasably securable to the first end region 211 of the handle 202. In some instances, the electric toothbrush 200 may additionally or alternatively include a rechargeable battery 208 (a nickel metal hydride (NiMH) battery or other type of rechargeable battery) and an electric motor 210. The rechargeable battery 208 may be disposed in the volume 214 and, further or instead, the electric motor 210 may be at least partially disposed in the volume 214. The electric motor 210 may be in mechanical communication with the brush head 204 to move the brush head 204 during a brushing procedure carried out by a user of the electric toothbrush 200. The pair of electrical contacts 206a,b may be in electrical communication with the rechargeable battery 208. To facilitate forming the electric toothbrush 200 with a form factor amenable to convenient for grasping and portable, the pair of electrical contacts 206a,b may be axially and radially spaced from one another, relative to the longitudinal axis L. That is, spacing the pair of electrical contacts 206a,b relative to one another along both the axial and radial dimensions of the electric toothbrush 200 may facilitate spacing the pair of electrical contacts 206a,b far enough from one another to have little or no likelihood of shorting while also facilitating forming the handle 202 with dimensions that may be easily grasp and, in some instances, may be similar to the form factor used for mechanical toothbrushes.

In some implementations, each one of the pair of electrical contacts 206a,206b may be radially centered about the longitudinal axis L of the handle 202 and each one of the pair of electrical contacts 206a, 206b may be symmetric about any plane containing the longitudinal axis. Such symmetry may be useful, for example, for connecting the electric toothbrush 200 to the charger 110 in a variety of orientations, without any specific circumferential alignment. Further, or instead, the pair of electrical contacts 206a, 206b may be partially disposed in the volume 214 of the handle 202, and each one of the pair of electrical contacts 206a,206b may extend from the volume 214 and through the second end region 212 of the handle 202. That is, the material forming the handle 202 may hold the pair of electrical contacts 206a, 206b fixed in place, even as the pair of electrical contacts 206a, 206b experience a variety of forces over multiple cycles of connection and disconnection to the charger 110.

The electric toothbrush 200 may include a chassis cap 228 supported on the second end region 212 of the handle 202. The second end region 212 of the handle 202, the chassis cap 228, and the pair of electrical contacts 206a,206b collectively form a continuous surface (e.g., an arcuate surface) of the electric toothbrush 200 with at least a portion of the chassis cap 228 disposed between the pair of electrical contacts 206a,206b along the continuous surface. For example, with close tolerance between the chassis cap 228, the pair of electrical contacts 206a, 206b, and the second end region 212 of the handle, the continuous surface may resist, or even prevent, ingress of fluid into the volume 214 defined by the handle 202. Additionally, or alternatively, the chassis cap 228 may be formed of an insulating material (e.g., plastic) and may maintain spacing between the pair of electrical contacts 206a, 206b to reduce the likelihood of short circuit, even as the electric toothbrush 200 experiences a variety of forces associated with toothbrushing, travel, charging, etc.

In certain implementations, one of the pair of electrical contacts 206a, 206b may circumscribe the other one of the pair of electrical contacts 206a, 206b, forming a ring contact (the electrical contact 206b) and center contact (the electrical contact 206a) arrangement. Continuing with this example, each one of the pair of electrical contacts 206a, 206b may have a longitudinal dimension along the longitudinal axis L, and the chassis cap 228 may space the pair of electrical contacts 206a, 206b apart from one another along the longitudinal dimension. Further, or instead, the chassis cap 228 may facilitate assembling the pair of electrical contacts 206a, 206b in such close proximity to one another within the small amount of space available in a form factor of the handle 202 suitable for grasping by a user using a typical grip associated with toothbrushing. For example, one or more of the pair of electrical contacts 206a,206b may be secured to the chassis cap 228 via a pressure sensitive adhesive (PSA) 230, as may be useful for aligning the pair of electrical contacts 206a, 206b relative to one another and relative to the chassis cap 228. Further, or instead, one or more of the pair of electrical contacts may be insert molded in the chassis cap 228, as may be particularly useful for reducing the likelihood of unintended ingress of liquid into the volume 214.

In some implementations, at least one of the pair of electrical contacts 206a, 206b may include one or more properties useful for aligning the pair of electrical contacts 206a, 206b relative to the charger 110 to initiate a charging cycle. For example, at least one of the pair of electrical contacts 206a, 206b may be ferromagnetic and electrically conductive. Such a ferromagnetic property may facilitate achieving blind self-alignment the pair of electrical contacts 206a, 206b using magnetic attraction, as may be particularly useful for establishing an electrical connection between the pair of electrical contacts 206, 206b and the charger 110 via the second opening 106 in the case 102. Further, or instead, such magnetic attraction may facilitate maintaining robust electrical contact between the pair of electrical contacts 206a, 206b and the charger 110, even as the electric toothbrush 200, the case 102, and/or the charger 110 experience forces (e.g., jostling). As an example, at least one of the pair of electrical contacts 206a,206b is at least partially formed of ferritic stainless-steel type 430 stainless, which is magnetic, corrosion resistant, electrically conductive, and cost-effectively sourced.

In certain implementations, the electric toothbrush 200 may include a PCBA 226 disposed in the volume 214 of the handle 202. The PCBA 226 may include one or more circuits and one or more processors. As an example, the PCBA 226 may be disposed between the rechargeable battery 208 and the chassis cap 228 along the longitudinal axis L and may be in electrical communication with the pair of electrical contacts 206a,206b and the rechargeable battery 208, with the PCBA managing the charging process according to any one or more of the various different techniques described herein. At least one of the pair of electrical contacts 206a,206b may include a tab that restricts longitudinal movement of the PCBA 226 relative to the chassis cap 228 within the volume of the handle 202. The PCBA 226 may include circuitry for selectively interrupting electrical communication between the rechargeable battery 208 and the electric motor 210.

The PCBA 226 may include an integrated controller for controlling electrical communication and/or electrical flow to the rechargeable battery 208. For example, the PCBA 226 may include circuitry, processors, and/or memory for controlling the electric motor 210 and for resetting the electric motor 210 for continued use according to any one or more of the various different methods described herein.

In some implementations, the handle 202 of the electric toothbrush 200 may include a first chassis section 244 and a second chassis section 246 disposed in the volume 214. The separation of the first chassis section 244 and the second chassis section 246 may facilitate forming one or more subassemblies that, in turn, facilitate forming the overall assembly of the electric toothbrush 200. As an example, the first chassis section 244 and the second chassis section 246 may be arranged such that the electric motor 210 is releasably securable to the first chassis section 244 and removable from the volume of the handle via the first end region 211 of the handle 202 with the brush head 204 disconnected from the first end region 211 of the handle 202. Additionally, or alternatively, the rechargeable battery 208 may be disposed longitudinally between at least a portion of the second chassis section 246 and the chassis cap 228. The first chassis section 244, the second chassis section 246, and the chassis cap 228 may each be discrete from one another and independently positionable within the volume 214. For example, as may be useful for facilitating repeatable and cost-effective assembly in high production volumes, a longitudinal position of the first chassis section 244 may be keyed to a first datum face of the first end region 211 of the handle 202, and a longitudinal position of the chassis cap 228 may be keyed to a second datum face of the second end region 212 of the handle 202. It shall be appreciated that the first datum face and the second datum face may each be a discrete longitudinal position within the volume 214 of the housing, as may be useful for achieving accurate longitudinal alignment of the first chassis section 244 and the second chassis section 246 relative to one another within the volume 214 such that components supported on the first chassis section 244 may be appropriately aligned (to within acceptable manufacturing tolerance) with respect to components supported on the second chassis section 246, ultimately facilitating blind assembly—namely, assembly without the benefit of direct line-of-sight—of components within the electric toothbrush within the volume 214 of the handle 202.

The first chassis section 244 may define a plurality of grooves 248 and the first chassis section 244 may be coupled to the handle 202 via adhesive in the grooves 248 between the first chassis section 244 and the handle 202. One or more instances of an O-ring may also, or instead, be disposed in at least some of the grooves 248 of the first chassis section 244, as may be useful for reducing the likelihood of ingress of moisture into portions of the volume 214 and onto electric components such as the PCBA 226 and/or the rechargeable battery 208. Further, or instead, the second chassis section 246 and the chassis cap 228 may be engageable with one another through snap-fit engagement, as may be useful for coupling second chassis section 246 to the chassis cap 228 by sliding one or both o of the second chassis section 246 and/or the chassis cap 228 longitudinally within the volume 214 defined by the handle 202. Such snap-fit engagement shall be understood to facilitate assembly of the electric toothbrush 200.

In some implementations, at least a portion of the second chassis section 246 may be longitudinally disposed between the rechargeable battery 208 and the electric motor 210 along the longitudinal axis L, and the rechargeable battery 208 may be longitudinally disposed between at least a portion of the second chassis section 246 and the chassis cap 228 in the volume 214 of the handle 202. That is, the electrical components of the electric toothbrush may be longitudinally disposed in a portion of the volume 214 between the chassis cap 228 and at least a portion of the second chassis section 246 such that this portion of the volume 214 may be sealed against undesirable liquid ingress that would otherwise degrade the electric components within the sealed portion of the volume 214.

In some instances, one of the pair of electrical contacts 206a, 206b (e.g., the electrical contact 206a) may define an orifice 247 along the continuous surface collectively defined by the handle 202, the chassis cap 228, and the pair of electrical contacts 206a, 206b. The orifice 247 may be in fluid communication with the rechargeable battery 208, as may be useful for off-gassing of the rechargeable battery 208 and, thus, for reducing the likelihood of an unsafe accumulation of hydrogen within the volume 214 during anomalous charging conditions. As described in greater detail below, one or more materials may be positioned between the orifice 247 and electronics within the volume 214 such that the portion of the volume 214 containing electronic components may remain water impermeable while also being gas permeable to support off-gassing through the orifice 247.

In certain implementations, a portion of the first chassis section 244 and a portion of the electric motor 210 may each extend from the volume 214 of the handle 202, through the first end region 211 of the handle 202, and into the brush head 204. Such positioning may facilitate making direct mechanical contact between the electric motor 210 and the brush head 204, with such direct mechanical contact facilitate efficient conversion of electrical energy from the rechargeable battery 208 into mechanical energy directable to the brush head 204. Further, or instead, with a portion of the electric motor 210 extending from the volume 214 of the handle, the electric motor 210 may be removed as part of routine repair and/or maintenance.

As described above, a portion of the volume 214 of the handle 202 includes electronics including a PCBA 226, a rechargeable battery 208, and other associated hardware (such as spring contacts). These electronics may become damaged by exposure to humidity and moisture. However, some amount of fluid exchange with the outside environment is also required for supporting off-gassing that may occur in certain use cases of the rechargeable battery 208. Stated differently, it is generally desirable to maintain water impermeability of at least a portion of the volume 214 of the handle 202 supporting the electronics of the electric toothbrush 200 while also allowing gas permeability of the same portion of the volume 214. To facilitate achieving these disparate performance goals, a first membrane 234 may be gas permeable and water impermeable. The first membrane 234 (e.g. a mesh material) may be disposed, in the volume 214, longitudinally between the rechargeable battery 208 and the orifice 247. Continuing with this example, the orifice 247 may be in fluid communication with the environment outside of the handle 202 such that gas exchange may occur from the rechargeable battery 208 and the outside environment, via the first membrane 234. Continuing still further with this example, water resistance of the first membrane 234 and the small size of the orifice 247 may substantially resist, or even prevent, water ingress into contact with the rechargeable battery 208 and/or the PCBA 226.

Further, or instead, a second membrane 236 may be disposed, in the volume 214, longitudinally between the rechargeable battery 208 and the electric motor 210. The second membrane 236 may be gas permeable and water impermeable. The second chassis section 246 may include a vent extending toward the brush head 204 to provide fluid communication between the second membrane 236 and the environment. The second membrane 235 may be formed of a mesh material and, in some instances, the second membrane 236 and the first membrane 234 may be formed of the same material.

In some implementations, the electric toothbrush 200 may include one or more flexible contacts to facilitate making and maintaining electrical connections between various electrical systems. These flexible contacts may include coiled springs and/or finger springs which advantageously permit small movements along the longitudinal axis L without losing electrical connectivity. For example, a flexible contact 250 may be supported on the second chassis section 246, such that a positive contact of the electric motor 210, a positive terminal of the rechargeable battery 208, and/or the PCBA 226 may be in electrical communication with one another via the flexible contact 250. The flexible contact 250 may be a spring contact in contact with the positive contact of the electric motor 210 and biased in a longitudinal direction from the second end region 212 toward the first end region 211. The flexible contact 250 may be, for example, heat staked to the second chassis section 246. Further, or instead, a strip contact 252 insert molded into the chassis cap 228. Still further, or instead, flexible contacts may include one or more wires soldered on the PCBA 226. One or more of these flexible contacts described herein may be used together in the electric toothbrush 200 as each of these flexible contacts advantageous improves connectivity and alignment.

In certain instances, the electric toothbrush 200 may include a first magnet 224 supported in the volume 214 of the handle 202 and in proximity to the pair of electrical contacts 206a,206b) to facilitate using magnetic force to maintain the pair of electrical contacts 206a, 206b in place on the charger 110. Advantageously, the first magnet 224 may engage any magnetic metal contacts of the charger 110 as the charger 110 and the first magnet 224 are brought near each other such that the first magnet 224 may facilitate achieving alignment of the pair of electrical contacts 206a, 206b with corresponding electrical contacts of the charger 110. The first magnet 224 may be encapsulated within the volume 214 of the handle 202 along the second end region 212 of the handle 202, as may be useful for maintaining the first magnet 224 free of debris or damage. Further, or instead, the first magnet 224 may be arranged radially between the pair of electrical contacts 206a,206b, as may be useful for aligning the pair of electrical contacts 206a, 206b with corresponding electrical contacts of the charger 110.

The electric toothbrush 200 may include one or more gaskets which may seal the first chassis section 244, the second chassis section 246, and/or the chassis cap 228 against a wall of the handle 202 and/or against one another. A gasket 254 may be disposed in the volume 214 of the handle 202, with the gasket 254 circumscribing the pair of electrical contacts 206a,206b along the second end region 212 of the handle 202, as may be useful for reducing the likelihood of water ingress around the pair of electrical contacts 206a, 206b. Gaskets (e.g., the gasket 254) may facilitate slidable assembly and disassembly of the chassis cap 228, the first chassis section 244, and/or the second chassis section 246 into the volume 214 defined by the handle 202 while also achieving water-sealing along various portions of the volume 214. While gaskets (e.g., the gasket 254) may be held in place by pressure in some instances, adhesive may be additionally or alternatively used to hold gaskets in place at least during assembly.

In some implementations, the electric motor 210 may include an automatic reset that shuts off the motor after a predetermined time period of total activity or a predetermined continuous running time. This automatic reset may advantageously reduce the likelihood of over-discharging the rechargeable battery 208. In some instances, PCBA 226 may additionally, or alternatively, include logic to reduce the likelihood of over-discharge of the rechargeable battery 208.

In certain implementations, the electric toothbrush 200 may include a controller on the PCBA 226 including one or more processors and a memory. The memory may include at least one non-transitory computer-readable storage medium communicatively coupled to the one or more processors. The at least one non-transitory computer-readable storage medium may have stored thereon instructions for causing the one or more processors to carry out any one or more of various, different aspects of operation of the electric toothbrush 200.

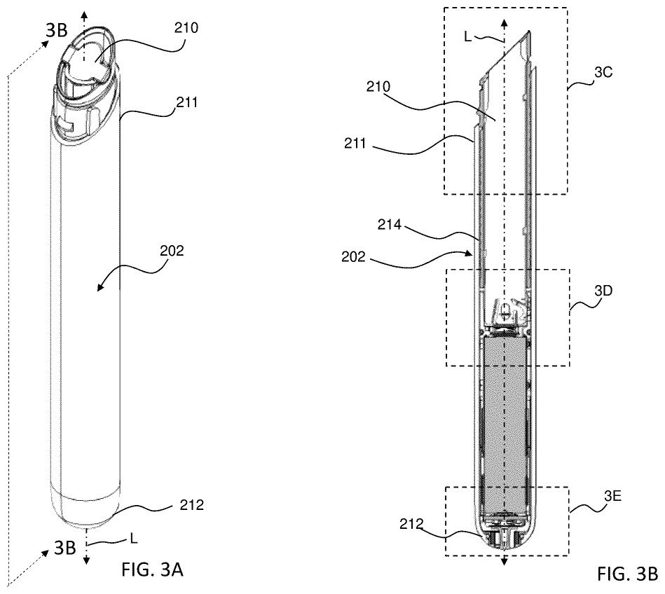

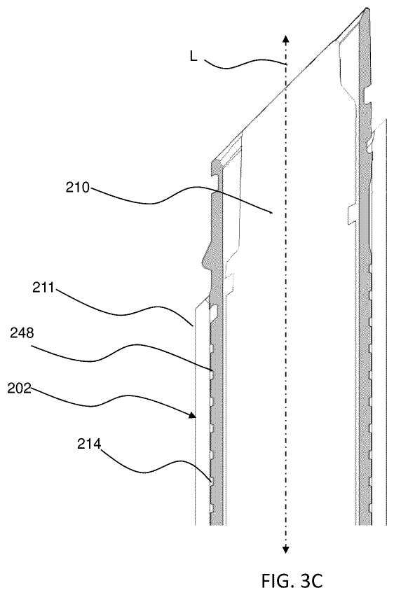

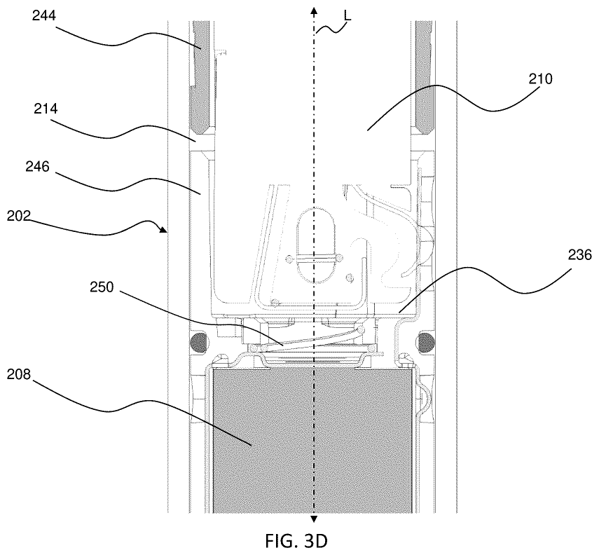

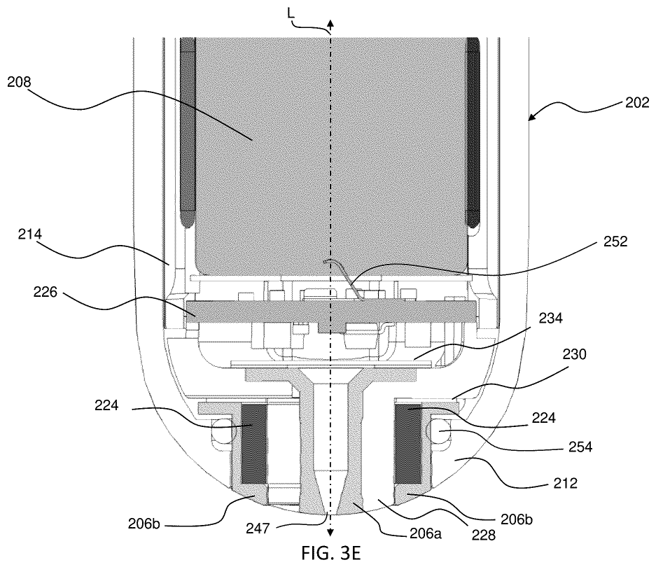

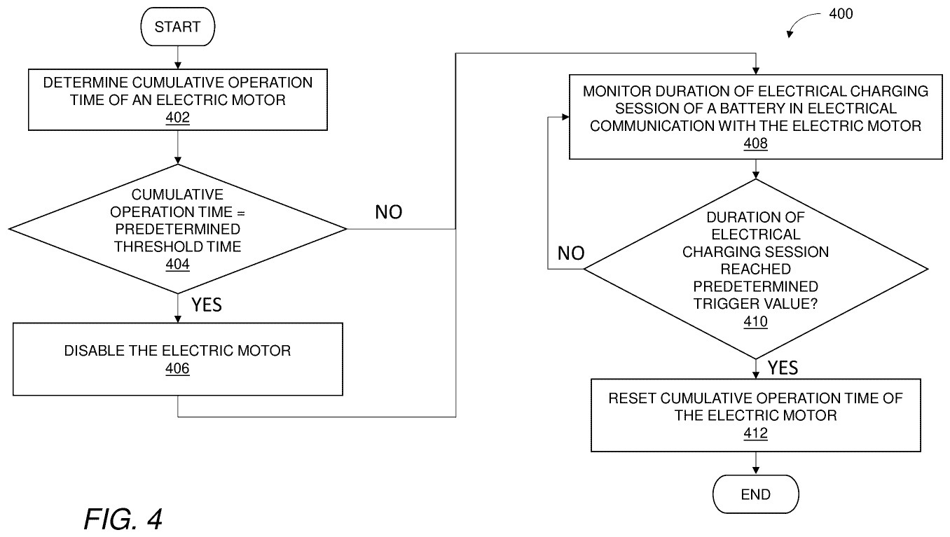

FIG. 4 is a flow chart of an exemplary method 400 of controlling over-discharging of a rechargeable oral care device. Unless otherwise specified or made clear from the context, it shall be appreciated that the exemplary method 400 may be carried out by a controller of the electric toothbrush 200 (FIG. 1B). For example, the memory of the PCBA 226 (FIG. 3E) may have stored thereon instructions for causing the one or more processors of the PCBA 226 (FIG. 3E) to carry out any one or more of various, different aspects of the exemplary method 400. For example, the electric motor 210 (FIG. 3C) may be in electrical communication with the PCBA 226 (FIG. 3E), which may monitor battery charging and may perform a power reset of the electric motor 210 (FIG. 3C) according to any one or more of the various different techniques described herein. module While the exemplary method 400 may be carried out by the electric toothbrush 200, it shall be appreciated that the exemplary method 400 may additionally or alternatively be carried out any on one or more of various, different other types of rechargeable oral care devices (e.g., oral irrigators) without departing from the scope of the present disclosure.

Motor modules (either regular or Bluetooth-enabled) may have a built-in safety timer which disables use after the electric motor 210 (FIG. 1B) has been actively used for 8 hours. This may correspond to approximately 4 months of normal use of the electric toothbrush 200 by a user. The intent of this timer is to reduce the likelihood of the user over-discharging the battery, which can lead to outgassing of the battery cell for certain battery chemistries. To reset the timer, typically the user may be required to power cycle the motor by physically removing the motor module from the toothbrush, removing the battery, re-inserting a new battery, and re-inserting the motor module. This power cycling of the motor module (i.e. removing power and re-applying power to the motor) may be the only way to reset this timer via the motor module itself.

In the electric toothbrush 200 (FIG. 1A) described herein, the battery may be rechargeable, so the user can recharge the battery after extended discharge and further, or instead, the battery may be a permanent part of the handle construction, making it difficult for the user to replace the battery or cycle power to the motor as may be required. To reduce the likelihood of a frustrating and confusing user experience for users who have fully or partially charged the electronic toothbrush, the PCBA 226 (FIG. 3E) and firmware on the electric toothbrush 200 may carry out one or more operations to power cycle the electric motor 210 (FIG. 1B) while the electric motor 210 remains in place in the electric toothbrush 200 (FIG. 1A)—that is, without requiring the user to remove and re-insert the electric motor 210 (FIG. 1B). This power reset may occur 30 min after charging has begun and the duration of the event (from power being removed to being re-applied) may last 15 seconds. Other values may additionally or alternatively be used.

As shown in step 402, the exemplary method 400 may include determining a cumulative activity time for an electric motor that is selectively actuatable to provide direct or indirect mechanical energy to a dental implement (e.g., a brush head). Determining the cumulative activity time for the electric motor may include detecting cumulative duration of an on state of the electric motor cycling between the on state and an off state.

As shown in step 404 and in step 406, the exemplary method 400 may include disabling the electric motor when the cumulative activity time reaches a predetermined threshold time. If the predetermined threshold is not reached in step 404, then the exemplary method 400 may return to step 402 and continue accumulating time (e.g., via a timer). The predetermined threshold time for disabling the electric motor may be greater than 6 hours and less than 10 hours. For example, the predetermined threshold time for disabling the electric motor may be 8 hours. Further, or instead, disabling the electric motor may include maintaining the electric motor in the off state. Still further, or instead, disabling the electric motor may include providing a warning signal to a user before shutoff. As an example, the warning signal may include actuating the electric motor to generate a predetermined vibration pattern. In some instances, disabling the electric motor may include receiving the predetermined threshold time via wireless communication (e.g., Bluetooth), wired communication (e.g., charger 110), or a combination thereof.

As shown in step 408, the exemplary method 400 may include monitoring a duration of an electrical charging session of a battery in electrical communication with the electric motor. Monitoring the duration of the electrical charging session may include detecting electrical energy (current) directed to the battery.

As shown in step 410, the exemplary method 400 may include comparing the duration of the electrical charging session to a predetermined trigger value. The predetermined trigger value for resetting the cumulative activity time for the electric motor may be greater than 10 minutes and less than 60 minutes. The predetermined trigger value for resetting the cumulative activity time may be 30 minutes. In certain instances, comparing the duration of the electrical charging session to the predetermined trigger value may include receiving the predetermined trigger value via wireless communication, wired communication, or a combination thereof.

As shown in step 412, the exemplary method 400 may include resetting the cumulative activity time for the electric motor when the duration of the electrical charging session reaches the predetermined trigger value. As an example, resetting the cumulative activity time for the electric motor may include enabling the electric motor following disablement of the electric motor. Further, or instead, resetting the cumulative activity time for the electric motor may include power cycling the electric motor, and the power cycling interrupts electrical communication between the battery and the electric motor for a predetermined interruption period. Still further, or instead, resetting the cumulative activity time for the electric motor may include reestablishing electrical communication between the battery and the electric motor following interruption of the electrical communication. In certain instances, resetting the cumulative activity time for the electric motor may include decrementing the cumulative activity time for the electric motor to zero. In some instances, as part of resetting the cumulative activity time, the predetermined power interruption period of the electric motor may be greater than 5 seconds and less than 60 seconds. For example, the predetermined interruption period may be 15 seconds.

In some implementations, resetting the cumulative activity time for the electric motor may include receiving the predetermined interruption period via wireless communication, wired communication, or a combination thereof. Further, or instead, resetting the cumulative activity time for the electric motor may include maintaining the battery and the electric motor fluidically sealed from the dental implement in mechanical communication with the electric motor.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

While particular embodiments have been shown and described, it will be apparent to those skilled in the art that various changes and modifications in form and details may be made therein without departing from the spirit and scope of this disclosure and are intended to form a part of the invention as defined by the following claims.

What is claimed is:

1. An electric toothbrush comprising:
a handle having a first end region and a second end region defining a longitudinal axis therebetween, the handle defining a volume from the first end region to the second end region;
a brush head including bristles, the brush head releasably securable to the first end region of the handle;
a rechargeable battery disposed in the volume;
an electric motor at least partially disposed in the volume, the electric motor in electrical communication with the rechargeable battery, the electric motor in mechanical communication with the brush head; and
a pair of electrical contacts in electrical communication with the rechargeable battery, and the pair of electrical contacts axially and radially spaced from one another, relative to the longitudinal axis.

2. The electric toothbrush of claim 1, wherein each one of the pair of electrical contacts is radially centered about the longitudinal axis of the handle.

3. The electric toothbrush of claim 1, wherein each one of the pair of electrical contacts is symmetric about any plane containing the longitudinal axis.

4. The electric toothbrush of claim 1, wherein the pair of electrical contacts are partially disposed in the volume of the handle, and each one of the pair of electrical contacts extends, from the volume, and through the second end region of the handle.

5. The electric toothbrush of claim 4, further comprising a chassis cap supported on the second end region of the handle, wherein the second end region of the handle, the chassis cap, and the pair of electrical contacts collectively form continuous surface of the electric toothbrush with at least a portion of the chassis cap disposed between the pair of electrical contacts along the continuous surface.

6. The electric toothbrush of claim 5, wherein one or more of the pair of electrical contacts is secured to the chassis cap via a pressure sensitive adhesive.

7. The electric toothbrush of claim 5, wherein one or more of the pair of electrical contacts is insert molded in the chassis cap.

8. The electric toothbrush of claim 5, further comprising a printed circuit board disposed in the volume of the handle and in electrical communication with the rechargeable battery, wherein at least one of the pair of electrical contacts includes a tab that restricts longitudinal movement the printed circuit board relative to the chassis cap within the volume of the handle.

9. The electric toothbrush of claim 5, further comprising a first chassis section and a second chassis section, wherein the electric motor is releasably securable to the first chassis section and removable from the volume of the handle via the first end region of the handle with the brush head disconnected from the first end region of the handle, and the rechargeable battery is disposed longitudinally between the second chassis section and the chassis cap.

10. The electric toothbrush of claim 9, wherein the first chassis section, the second chassis section, and the chassis cap are each discrete from one another and independently positionable within the volume, a longitudinal position of the first chassis section is keyed to a first datum face of the first end region of the handle, and a longitudinal position of the chassis cap is keyed to a second datum face of the second end region of the handle.

11. The electric toothbrush of claim 9, wherein the first chassis section defines a plurality of grooves, and the first chassis section is coupled to the handle via adhesive in the grooves between the first chassis section and the handle.

12. The electric toothbrush of claim 9, wherein the first chassis section and the second chassis section are longitudinally spaced from one another in the volume of the handle.

13. The electric toothbrush of claim 9, wherein the second chassis section and the chassis cap are engageable with one another through snap-fit engagement.

14. The electric toothbrush of claim 9, wherein the second chassis section is disposed between the rechargeable battery and the electric motor along the longitudinal axis, and the rechargeable battery is disposed between the second chassis section and the chassis cap in the volume of the handle.

15. The electric toothbrush of claim 5, wherein one of the pair of electrical contacts defines an orifice along the continuous surface, and the orifice is in fluid communication with the rechargeable battery.

16. The electric toothbrush of claim 9, further comprising a flexible contact supported on the second chassis section, wherein a positive contact of the electric motor, a positive terminal of the rechargeable battery, and the printed circuit board are in electrical communication with one another via the flexible contact.

17. The electric toothbrush of claim 1, wherein the pair of electrical contacts include a ring contact and a center contact, and the ring contact circumscribes the center contact.

18. The electric toothbrush of claim 1, further comprising a permanent magnet encapsulated within the volume of the handle along the second end region of the handle.

19. A dental care system comprising:
an electric toothbrush including a handle, a brush head, and a pair of electrical contacts, the brush head supported on the handle, and the pair of electrical contacts supported on the handle away from the brush head; and
a case defining a first opening and a second opening, the case defining a cavity from the first opening to the second opening, the case positionable about at least a portion of the handle with at least a portion of the electric toothbrush extending through the first opening and the pair of electrical contacts accessible in the cavity through the second opening from an environment outside of the case.

20. A method of controlling over-discharging of a rechargeable oral care device, the method comprising:
determining a cumulative activity time for an electric motor selectively actuatable to direct mechanical energy to a dental implement;
disabling the electric motor when the cumulative activity time reaches a predetermined threshold time;
monitoring a duration of an electrical charging session of a battery in electrical communication with the electric motor;
comparing the duration of the electrical charging session to a predetermined trigger value; and
resetting the cumulative activity time for the electric motor when the duration of the electrical charging session reaches the predetermined trigger value.
